(19) United States
(12) Patent Application Publication
(10) Pub. No.: US 2013/0293909 A1
(43) Pub. Date: Nov. 7, 2013

(54) IMAGE FORMING APPARATUS

(71) Applicant: CANON KABUSHIKI KAISHA, Tokyo (JP)

(72) Inventors: Hiroto Endo, Hadano-shi (JP); Masaru Aoki, Numazu-shi (JP); Atsushi Ogata, Mishima-shi (JP)

(73) Assignee: CANON KABUSHIKI KAISHA, Tokyo (JP)

(21) Appl. No.: 13/869,137

(22) Filed: Apr. 24, 2013

(30) Foreign Application Priority Data
May 7, 2012 (JP) 2012-106109

(51) Int. Cl. H04N 1/00

(52) U.S. Cl. CPC H04N 1/00596; H04N 1/00572
USPC 358/1.12

(57) ABSTRACT

The image forming apparatus includes a conveyance path that is used to convey a recording material to form an image on the recording material, a reading unit that reads an original conveyed in the conveyance path, and a control unit that controls a recording material conveyance operation to selectively convey the recording material and the original to the conveyance path.

### BACKGROUND OF THE INVENTION

1. Field of the Invention

The present invention relates to an original reading apparatus typified by an auto document feeder unit (ADF) or an image forming apparatus typified by a copying machine or laser beam printer including the ADF.

2. Description of the Related Art

Conventionally in an image forming apparatus of this type, an original conveyance path for conveying an original to an original reading unit, and a recording material conveyance path for conveying a recording material to an image forming unit are formed independently of each other. More specifically, sheet feeding units, guide members each forming a predetermined conveyance path, a plurality of conveyance rollers, motors for driving the conveyance rollers, discharge units, and the like are arranged independently for an original and recording material. It is therefore inevitable to complicate the whole mechanism of the image forming apparatus and increase the cost and apparatus size. To solve this, for example, Japanese Patent Application Laid-Open No. 2006-232467 proposes an image forming apparatus in which an original reading means is arranged in a turnover conveyance path for performing a double-sided print on a recording material, and an original conveyance path and recording material conveyance path are commonly used, thereby simplifying the conveyance mechanism and decreasing the cost and size.

In the image forming apparatus proposed by Japanese Patent Application Laid-Open No. 2006-232467, the original reading means is arranged in the turnover conveyance path. Thus, when an original exists in the turnover conveyance path and is under an original reading operation, a print operation on a recording material stops, decreasing the productivity of the image forming apparatus.

### SUMMARY OF THE INVENTION

Under the circumstances, a purpose of the present invention is to provide an image forming apparatus which parallelly executes an original reading operation and recording material image forming operation with a simple arrangement, thereby increasing the productivity.

Another purpose of the present invention is to provide an image forming apparatus including a first conveyance path in which a recording material to form an image on the recording material is conveyed, an image forming unit that forms an image on a recording material conveyed in the first conveyance path, a second conveyance path in which a conveyance direction of a recording material conveyed in the first conveyance path is switched and conveyed, wherein an image is formed on the recording material by the image forming unit, a switching unit that, when an original conveyed in the second conveyance path is detected, switches an conveyance path of the original and conveys the original in a third conveyance path, a reading unit that reads an image of the original conveyed in the second conveyance path and the third conveyance path, and a control unit that controls a conveyance operation for an original or a recording material to parallelly perform reading of the image of the original by the reading unit and image formation of the read image of the original by the image forming unit.

A further purpose of the present invention is to provide an image forming apparatus including an image forming unit that forms an image on a recording material, a conveyance path that is used to convey the recording material to form an image on the recording material, a reading unit that reads an original conveyed in the conveyance path, and a control unit that controls a recording material conveyance operation to selectively convey the recording material and the original to the conveyance path.

Further features of the present invention will become apparent from the following description of exemplary embodiments with reference to the attached drawings.

### BRIEF DESCRIPTION OF THE DRAWINGS

FIG. 1A is a sectional view of an image forming apparatus in the first embodiment.

FIG. 1B is a sectional view of the image forming apparatus in the first embodiment to explain a double-sided print process.

FIGS. 2A and 2B are views for explaining an original double-sided reading operation and recording material double-sided print operation in the first embodiment.

FIGS. 2C and 2D are views for explaining the original double-sided reading operation and recording material double-sided print operation in the first embodiment.

FIG. 2E is a view for explaining the original double-sided reading operation and recording material double-sided print operation in the first embodiment.

FIG. 3 is a block diagram showing the arrangement of a control unit in the first, second, and third embodiments.

FIG. 4 is a block diagram showing the circuit arrangement of an original reading unit in the first, second, and third embodiments.

FIG. 5 is a timing chart of original reading and recording material printing in the first embodiment.

FIG. 6 is a view showing the positional relationship between an original and a recording material on a conveyance path in the first embodiment.

FIG. 7A is a timing chart showing original reading and recording material printing in the second embodiment.

FIG. 7B is a view showing the positional relationship between an original and a recording material on a conveyance path in the second embodiment.

FIG. 8A is a timing chart showing original reading and recording material printing in the third embodiment.

FIG. 8B is a view showing the positional relationship between an original and a recording material on a conveyance path in the third embodiment.

### DESCRIPTION OF THE EMBODIMENTS

Preferred embodiments of the present invention will now be described in detail in accordance with the accompanying drawings.

### First Embodiment

[Image Forming Process in Image Forming Apparatus]

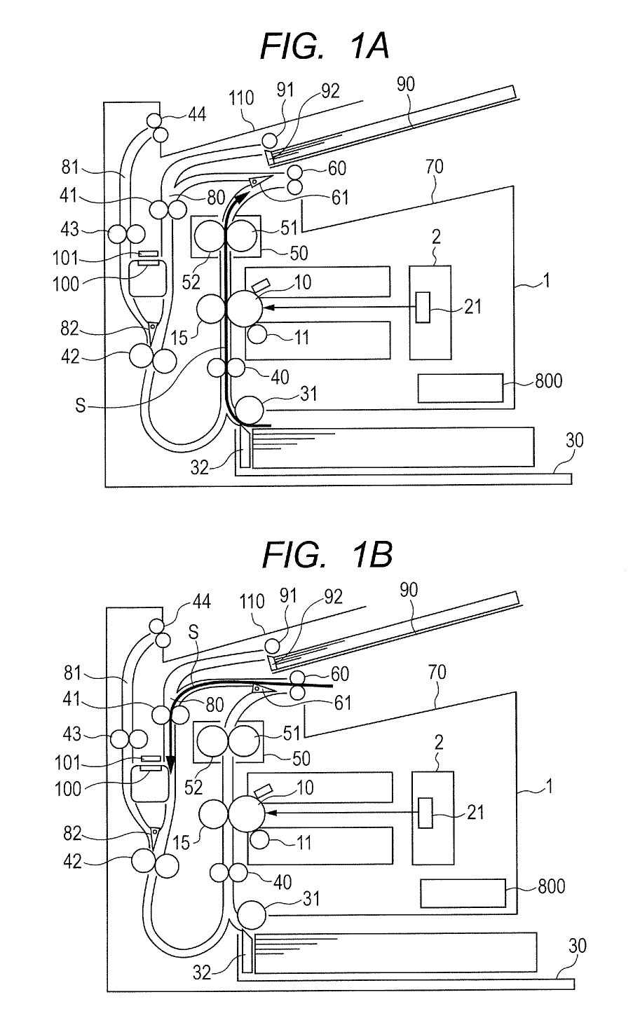

An image forming process will be described first. FIG. 1A is a sectional view of an image forming apparatus 1 in the first embodiment. In FIG. 1A, a rotatable photosensitive drum 10 serving as an image carrier, and a developing roller 11 which is juxtaposed with the photosensitive drum 10 and rotates while holding toner are arranged at the center of the image forming apparatus 1. Upon receiving an image forming instruction, a light emitting unit 21 of an optical unit 2 irradiates the surface of the rotating photosensitive drum 10 with a laser beam. A latent image is formed by charges on the surface of the photosensitive drum 10 irradiated with the laser beam. The toner held by the developing roller 11 is applied to the latent image on the surface of the photosensitive drum 10 to develop the latent image, thereby forming a toner image on the surface of the photosensitive drum 10.

A first sheet feeding unit 30 serving as a first sheet feeding means stores recording materials S which are conveyed in a conveyance path for image formation serving as the first conveyance path formed between conveyance rollers 40 and discharge rollers 60, and which undergo image formation. Upon receiving an image forming instruction, the recording materials S are conveyed one by one by a cassette (to be referred to as CST hereinafter) pickup roller 31 and separation member 32 to the conveyance rollers 40. The conveyance rollers 40 adjust the conveyance timing, and convey the recording material S to a transfer roller 15 so that the toner image on the photosensitive drum 10 is transferred to a predetermined position on the recording material S.

The toner image on the photosensitive drum 10 is transferred to the recording material S by a transfer bias and pressure applied to the transfer roller 15, and the recording material S is conveyed to a fixing unit 50. In the fixing unit 50, the toner image is fixed to the recording material S by heat of a heating roller 51, and the pressure of a pressure roller 52 facing the heating roller 51. The recording material S on which the toner image is fixed is conveyed to the discharge rollers 60.

For a single-sided print, the discharge rollers directly convey the recording material S outside the apparatus, and the recording material S is stacked on a first discharge unit 70. For a double-sided print, discharge rollers 60 convey the recording material S until the conveyance-direction trailing edge (to be referred to as a “trailing edge” hereinafter) of the recording material S passes through a double-sided flapper 61. When it is detected that the recording material S has passed through the double-sided flapper 61, the double-sided flapper 61 switches the conveyance destination of the recording material S to a common conveyance path 80 serving as the second conveyance path through which both the recording material S and an original G are conveyed. Then, the discharge rollers 60 rotate reversely to convey the recording material S to the common conveyance path 80. As shown in FIG. 1B, the switched-back recording material S is conveyed to an original reading unit 100 by conveyance rollers 41. Further, the recording material S is conveyed again to the transfer roller 15 by conveyance rollers 42 and the conveyance rollers 40. After a toner image is transferred to the other surface of the recording material S and fixed to the recording material S by the fixing unit 50, the recording material S is stacked on the first discharge unit 70 by the discharge rollers 60.

[Double-Sided Reading Operation for Original and Double-Sided Print Operation for Recording Material]

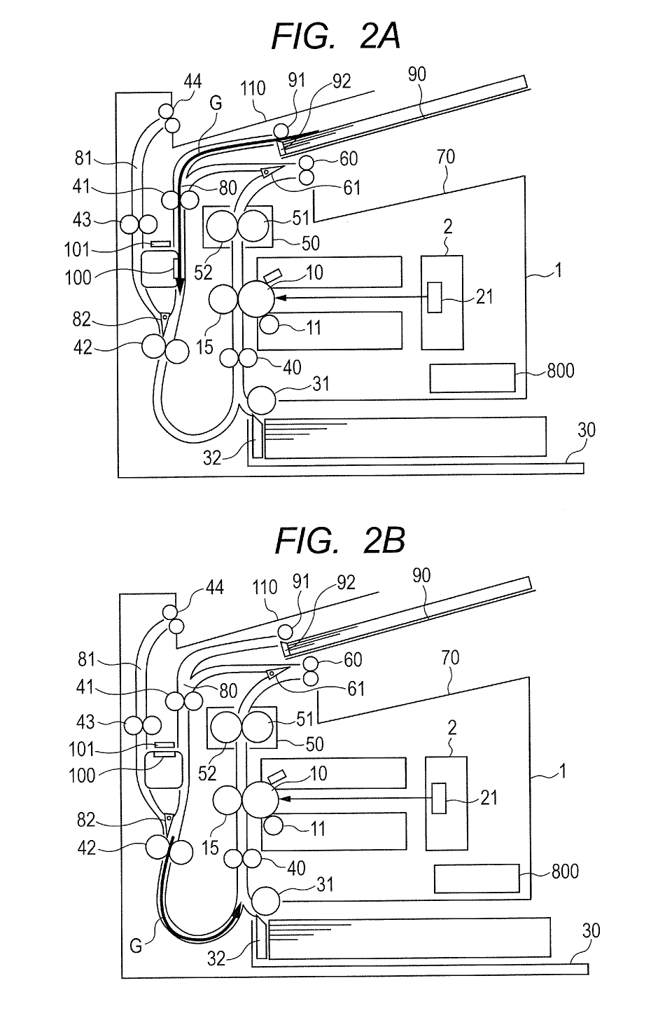

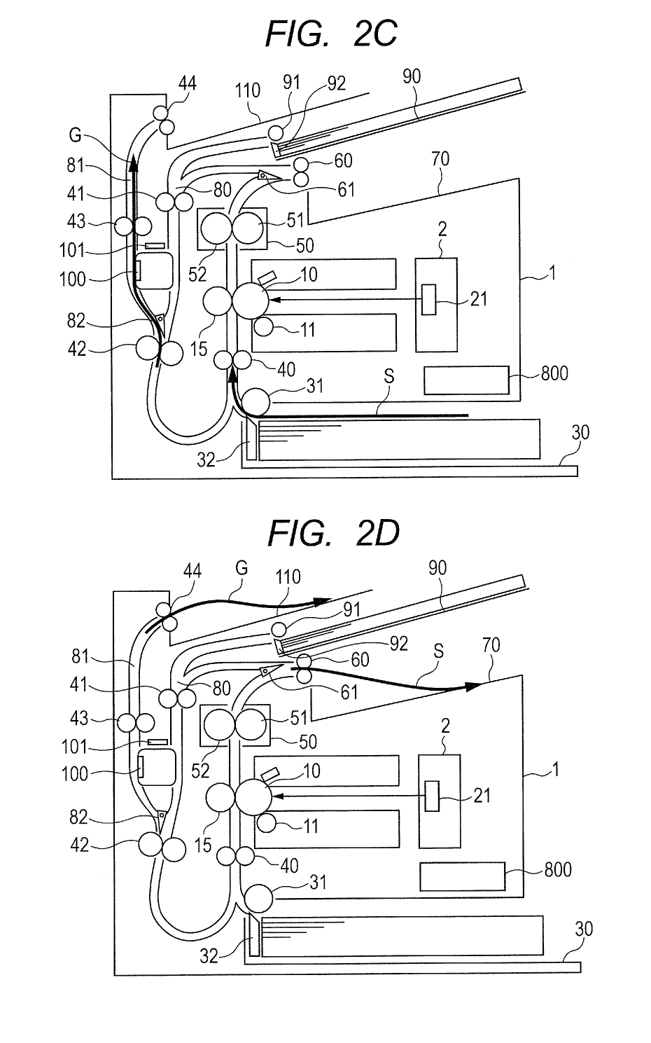

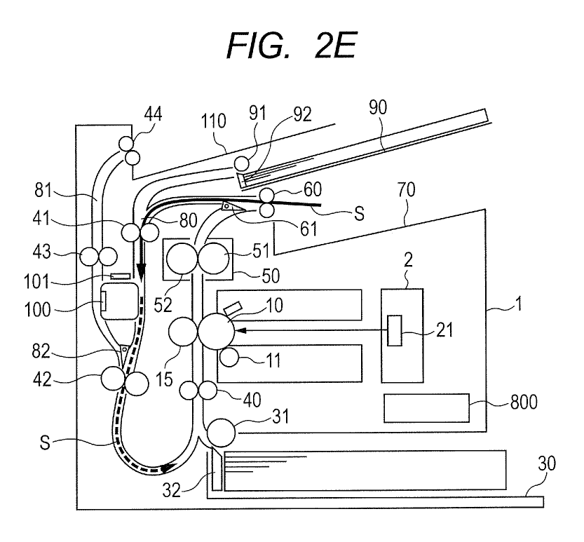

A process to execute reading of an original image and a double-sided print on a recording material will be explained. FIG. 2A is an explanatory view showing a state at the start of reading the surface of the original G. The originals G stored in a second sheet feeding unit 90, which is arranged upstream in the conveyance direction of the common conveyance path 80 and serves as the second sheet feeding means, are conveyed one by one by an original pickup roller 91 and separation member 92 to the conveyance rollers 41. The original reading unit 100 executes emission to a white reference member 101 and correction of the white reference value before the start of reading the first surface serving as the top surface of the original G conveyed from the second sheet feeding unit 90. Then, the original reading unit 100 rotates to a position where it faces the common conveyance path 80. The conveyance rollers 41 convey the original G to the original reading unit 100. If the original reading unit 100 detects the conveyance-direction leading edge (to be referred to as a “leading edge” hereinafter) of the original G, it reads an image on the original G. The image read by the original reading unit 100 is stored as original image data of the first surface of the original in an image memory 804 to be described later.

FIG. 2B is an explanatory view showing a state at the end of reading the first surface serving as the top surface of the original G. The original G having passed through the original reading unit 100 is conveyed to the conveyance rollers 42. When it is detected that the trailing edge of the original G has passed through a switchback flapper 82, the conveyance rollers 42 stop, and the original G stops while being clamped by the conveyance rollers 42.

FIG. 2C is an explanatory view showing a state at the start of reading the second surface serving as the back surface of the original G. When the switchback flapper 82 switches the conveyance path of the original G from the common conveyance path 80 to an original dedicated conveyance path 81 serving as the third conveyance path, the original reading unit 100 rotates to the position where it faces the original dedicated conveyance path 81. The conveyance rollers 42 rotate reversely to convey the original G in an opposite direction toward the original reading unit 100 along the original dedicated conveyance path 81. If the original reading unit 100 detects the leading edge of the original G, it reads the image of the second surface serving as the back surface of the original G, and stores it as original image data of the second surface of the original in the image memory 804. If the back surface of the original G is not read, the original G is conveyed by conveyance rollers 43 and 44 through the original dedicated conveyance path 81, and stacked on a second discharge unit 110.

The recording materials S fed from the first sheet feeding unit 30 are conveyed one by one to the conveyance rollers 40. First, a latent image based on the original image data of the second surface serving as the back surface of the original G that is stored in the image memory 804 is formed on the photosensitive drum 10 by a laser beam emitted by the light emitting unit 21 to the photosensitive drum 10. After the transfer roller 15 transfers, to the recording material S, a toner image formed by developing the latent image, the recording material S is conveyed to the fixing unit 50, completing the image formation of the second surface of the original G. In FIG. 2C, feeding of the recording material S starts at the same time as the start of reading the image of the second surface serving as the back surface of the original G. However, feeding of the recording material may start after reading the image of the second surface of the original G.

FIG. 2D is an explanatory view showing a state after the end of reading the back surface of the original G. After the end of reading the original, the original G is conveyed by the conveyance rollers 43 and 44, and stacked on the second discharge unit 110. After the trailing edge of the original G passes through the switchback flapper 82, the switchback flapper 82 switches the conveyance path of the recording material S from the original dedicated conveyance path 81 to the common conveyance path 80 so as to convey the recording material S conveyed in the common conveyance path 80 toward the conveyance rollers 40. The recording material S having undergone the image formation of the second surface of the original is conveyed to the common conveyance path 80 switched by the double-sided flapper 61 by reverse rotation of the discharge rollers 60 arranged downstream in the conveyance direction of the recording material S.

FIG. 2E is an explanatory view showing a state in which the recording material S is conveyed to an image forming unit in order to form the image of the first surface of the original G on the recording material S. The recording material S conveyed to the common conveyance path 80 serving as a double-sided conveyance path for forming an image on the second surface of a recording material having the first surface on which an image has been formed passes through the original reading unit 100 having a sensor facing the original dedicated conveyance path 81, and is conveyed to the conveyance rollers 42. The recording material S is conveyed again to the transfer roller 15 by the conveyance rollers 40 and 42, as indicated by a broken line. A toner image based on the original image data of the first surface of the original G that has been stored in the image memory 804 is formed on the recording material S having undergone the image formation of the second surface of the original G. Then, the recording material S is stacked on the first discharge unit 70.

[Outline of Control Unit of Image Forming Apparatus]

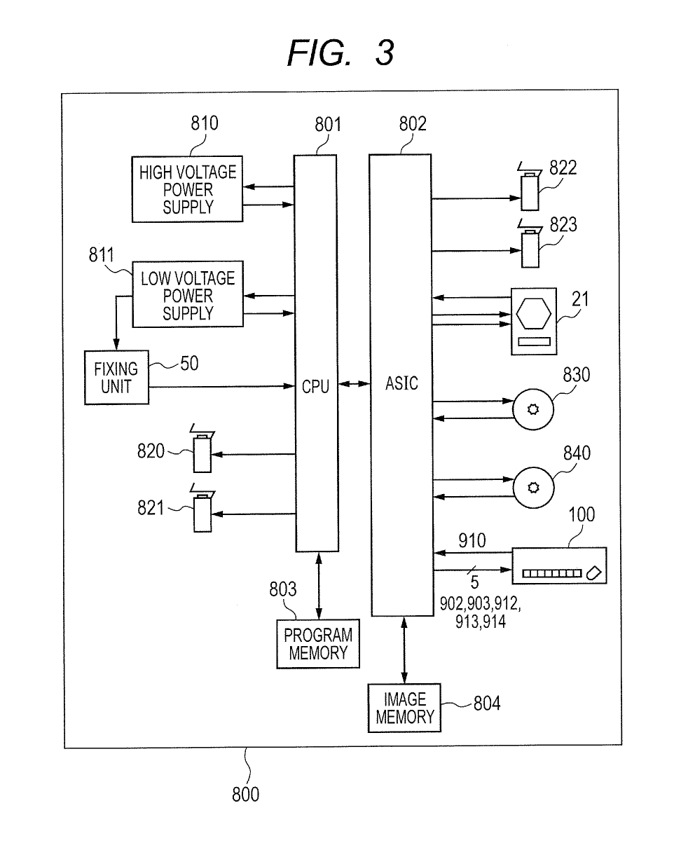

FIG. 3 is a block diagram showing the arrangement of a control unit 800 including a CPU 801 which controls the image forming apparatus 1. In FIG. 3, the light emitting unit 21 including a rotating polygon mirror, motor, and laser emitting element is connected to an application specific integrated circuit (ASIC) 802. The CPU 801 outputs a control signal to the ASIC 802 to control the light emitting unit 21 of the optical unit 2 in order to scan the surface of the photosensitive drum 10 with a laser beam and draw a desired latent image. A main motor 830 drives the CST pickup roller 31, conveyance rollers 40, photosensitive drum 10, transfer roller 15, heating roller 51, and pressure roller 52 in order to convey the recording material S. A double-sided driving motor 840 drives a CST sheet feeding solenoid 822 which is turned on at the start of driving a sheet feeding roller for feeding the recording material S and drives the CST pickup roller 31, the original pickup roller 91, and the conveyance rollers 41 to 44. The CPU 801 controls a driving system including the main motor 830 and double-sided driving motor 840 via the ASIC 802.

The CPU 801 controls a high voltage power supply 810 and low voltage power supply 811 which control a charging bias, developing bias, and transfer bias necessary for an electrophotographic process, and the fixing unit 50. The CPU 801 detects a temperature by using a thermistor (not shown) arranged in the fixing unit 50, and controls to keep the temperature of the fixing unit 50 constant.

A program memory 803 is connected to the CPU 801 via a bus (not shown). The program memory 803 stores programs and data for executing processing to be performed by the CPU 801. The CPU 801 controls the operation of the image forming apparatus 1 based on the programs and data stored in the program memory 803.

The ASIC 802 controls the speed of a motor in the light emitting unit 21 and the speeds of the main motor 830 and double-sided driving motor 840 based on instructions from the CPU 801. The ASIC 802 controls the motor speed by detecting a tachometer signal (pulse signal output from a motor every time the motor rotates) output from each motor, and outputting an acceleration or deceleration signal to the motor to set the output interval between tachometer signals to be a predetermined time. Controlling the motor and the like by a hardware circuit such as the ASIC 802 can reduce the control load on the CPU 801.

A control operation by the control unit 800 in printing on a recording material will be explained. Upon receiving a print command from a host computer (not shown) to print on a recording material, the CPU 801 conveys the recording material S by driving the main motor 830, double-sided driving motor 840, and CST sheet feeding solenoid 822 via the ASIC 802. The transfer roller 15 transfers a toner image formed on the surface of the photosensitive drum 10 to the recording material S, and the fixing unit 50 fixes the toner image to the recording material. Then, the discharge rollers 60 discharge the recording material S to the first discharge unit 70 serving as a recording material stacking unit. To improve alignment of recording materials, the first discharge unit 70 has a gentle up slope formed from the vicinity of the discharge port in the recording material discharge direction. The CPU 801 supplies predetermined power from the low voltage power supply 811 to the fixing unit 50 to generate a desired amount of heat in the fixing unit 50 and heat the recording material S, thereby fusing the toner image on the recording material S and fixing it to the recording material S.

A control operation by the control unit 800 in original reading will be explained. Upon receiving a scan command from the host computer (not shown) to read the original G, the CPU 801 operates an original feeding solenoid 823 by driving a double-sided flapper solenoid 820 and the double-sided driving motor 840 via the ASIC 802. The torque of the double-sided driving motor 840 is transmitted to the original pickup roller 91 to convey the original G. The original reading unit 100 reads the original G based on a CISSTART signal 902, CISLED signal 903, Sl_in signal 912, Sl_select signal 913, and SYSCLK signal 914 which are control signals from the ASIC 802. Details of these control signals will be described later. The CPU 801 saves, in the image memory 804 connected to the ASIC 802, read original image data output as an Sl_out signal 910 from the original reading unit 100 under control via the ASIC 802. After that, the CPU 801 operates a switchback solenoid 821 to switch the switchback flapper 82 to the original dedicated conveyance path 81, reversely rotates the double-sided driving motor 840, and conveys the original G to the second discharge unit 110.

[Outline of Original Reading Unit]

Next, details of the original reading unit 100 will be explained with reference to FIG. 4. FIG. 4 is a block diagram showing the circuit arrangement of the original reading unit 100. Referring to FIG. 4, in a CIS (Contact Image Sensor) sensor 901, for example, photodiodes for 10,368 pixels are arrayed at a specific main scanning density (for example, 1,200 dpi). The CISSTART signal 902 is an original reading start pulse signal input to the CIS sensor. The CISLED signal 903 is a control signal for controlling a light emitting unit 907. A current amplifier 906 controls a current to be supplied to the light emitting unit 907 based on the CISLED signal 903, and the light emitting unit 907 irradiates the original G uniformly. A timing generator 917 receives the SYSCLK signal 914, and generates an ADCLK signal 916 and CISCLK signal 915. The SYSCLK signal 914 is a system clock which determines the operating speed of the original reading unit 100. The ADCLK signal 916 is a sampling clock which determines the sampling speed of an A/D converter 908. The CISCLK signal 915 is used as the transfer clock of a CISSNS signal 918 serving as an output signal from a shift register 905.

Next, an original reading operation will be explained. When the CISSTART signal 902 is input, the CIS sensor 901 starts accumulating charges based on light which has been emitted by the light emitting unit 907, reflected by the original G, and received. The CIS sensor 901 sequentially sets the charge data accumulated in an output buffer 904. The timing generator 917 outputs, to the shift register 905, the CISCLK signal 915 having a clock frequency of, for example, about 500 kHz to 1 MHz. The shift register 905 outputs the charge data set in the output buffer 904 as the CISSNS signal 918 to the A/D converter 908 in synchronism with the input CISCLK signal 915. Since the CISSNS signal 918 has a predetermined data assurance area, the A/D converter 908 needs to sample the CISSNS signal 918 a predetermined time after the leading edge of the CISCLK signal 915 serving as a transfer clock. The shift register 905 outputs the CISSNS signal 918 in synchronism with both the leading and trailing edges of the CISCLK signal 915 serving as a transfer clock. The timing generator 917 generates the ADCLK signal 916 serving as a clock for sampling the CISSNS signal 918, so that the frequency of the ADCLK signal 916 becomes double the frequency of the CISCLK signal 915. The CISSNS signal 918 is sampled at the leading edge of the ADCLK signal 916. The timing generator 917 divides the frequency of the input SYSCLK signal 914 serving as a system clock, generating the ADCLK signal 916 and the CISCLK signal 915 serving as a transfer clock. The phase of the ADCLK signal 916 is delayed from that of the CISCLK signal 915 serving as a transfer clock by the data assurance area.

The CISSNS signal 918 is digitized by the A/D converter 908, and output to an output interface circuit 909. The output interface circuit 909 outputs the CISSNS signal 918 as the Sl_out signal 910 of serial data at a predetermined timing. At this time, an analog output reference voltage is output for the CISSNS signal 918 corresponding to a predetermined number of pixels from the CISSTART signal 902 serving as a start pulse, and these pixels cannot be used as effective pixels.

A control circuit 911 controls the A/D conversion gain of the A/D converter 908 based on the Sl_in signal 912 and Sl_select signal 913 from the CPU 801 via the ASIC 802. For example, when the contrast of a read original image cannot be obtained, the CPU 801 increases the A/D conversion gain of the A/D converter 908 to increase the contrast, and an original can always be read with a best contrast.

An apparatus arrangement in which image information of all pixels is output as the CISSNS signal 918 serving as one output signal has been described. However, pixels may be divided into respective areas for high-speed original reading, and pixel data of a plurality of areas may be A/D-converted simultaneously. An embodiment in which the original reading unit 100 uses the CIS sensor has been explained, but the CIS sensor can be replaced with a CMOS sensor, CCD sensor, or the like.

[Timing Control in Single-Sided Reading of Original and Single-Sided Print of Recording Material]

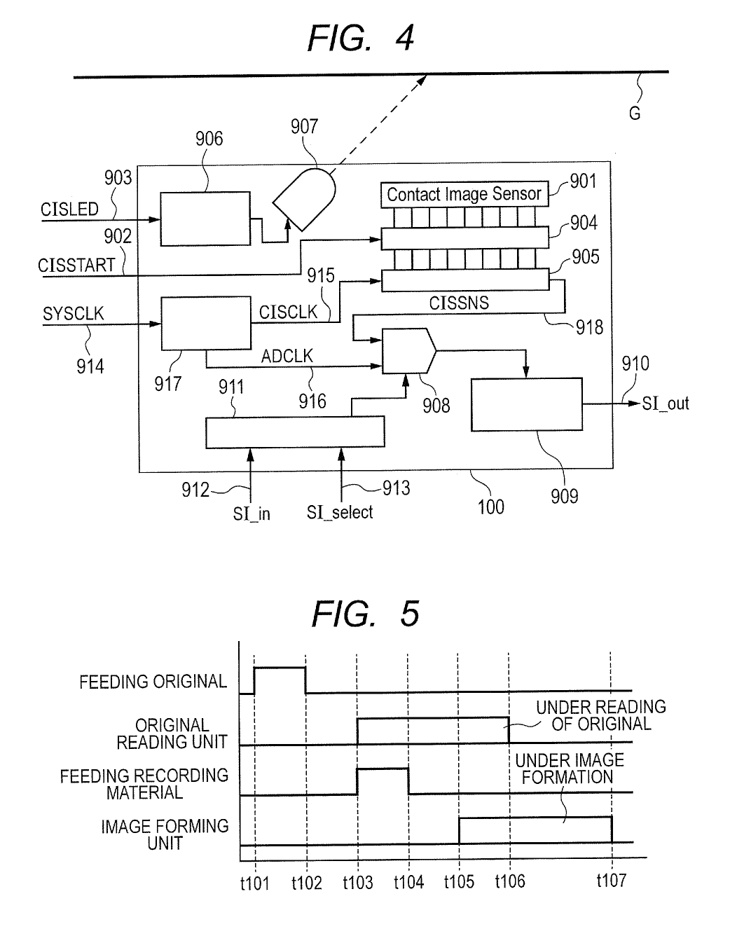

FIG. 5 exemplifies a timing chart when single-sided reading of an original and a single-sided print of read original image data on a recording material are executed within a short time in order to increase the productivity of the image forming apparatus 1 in the arrangement of the image forming apparatus 1 according to the embodiment. In FIG. 5, the abscissa represents the time, and t101 to t107 are timings in the timing chart. The ordinate represents the states of the original G and recording material S, and the operating state of the apparatus (image forming unit and original reading unit) on the conveyance path. Pulse-like periods between t101 and t102 and between t103 and t104 in original feeding and recording material feeding are a period during which the original G is fed from the second sheet feeding unit 90, and a period during which the recording material S is fed from the first sheet feeding unit 30, respectively. “Under reading of original” (t103 to t106) is a period from the start to end of reading the original G in the original reading unit 100. “Under image formation” (t105 to t107) is a period which starts from formation of a latent image on the photosensitive drum 10 and during which a toner image is transferred to the recording material S and fixed to it by the fixing unit 50.

At t101, the CPU 801 drives the original pickup roller 91, and conveys the original G stored in the second sheet feeding unit 90 to the conveyance rollers 41 by the original pickup roller 91 and separation member 92. At t102 a predetermined time after t101, the CPU 801 stops the original pickup roller 91. The conveyance rollers 41 convey the original G fed from the second sheet feeding unit 90 to the original reading unit 100. To read an image on the conveyed original G, the sensor of the original reading unit 100 for reading an original stays at a position where it faces the common conveyance path 80. If the sensor detects the arrival of the leading edge of the original G at t103, the original reading unit 100 starts reading the image on the original G. The output interface circuit 909 of the original reading unit 100 outputs the read image to the ASIC 802, and the ASIC 802 stores it as original image data of the first surface of the original G in the image memory 804. After the start of reading the original G at t103, the CPU 801 conveys the recording material S stored in the first sheet feeding unit 30 to the conveyance rollers 40 by the CST pickup roller 31 and separation member 32. At t104 a predetermined time after t103, the CPU 801 stops the CST pickup roller 31 in order to stop the feeding of the recording material from the first sheet feeding unit 30. At t105, in synchronism with the timing to convey the recording material S to the transfer roller 15, the image forming unit forms a latent image on the photosensitive drum 10 by a laser beam emitted by the light emitting unit 21 based on the original image data of the original G that is stored in the image memory 804. At t106, when the conveyance-direction trailing edge (to be referred to as a “trailing edge” hereinafter) of the original G passes through the original reading unit 100, the original reading unit 100 ends the reading of the original. The image forming unit develops the latent image on the photosensitive drum 10 into a toner image. The toner image is transferred onto the recording material S by a transfer bias and pressure applied to the transfer roller 15, and the recording material S is conveyed to the fixing unit 50. The fixing unit 50 fixes the toner image to the recording material S by heat of the heating roller 51 and the pressure of the pressure roller 52. At t107 when the recording material S passes through the image forming unit, the image formation ends. The recording material S on which the toner image is fixed is conveyed outside the apparatus by the discharge rollers 60, and stacked on the first discharge unit 70.

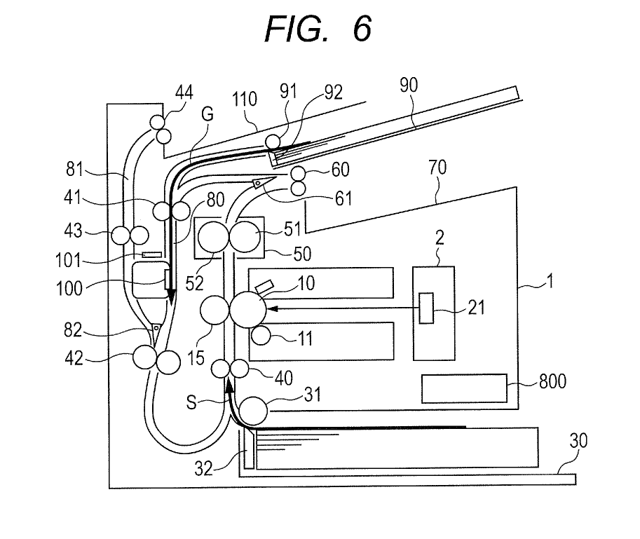

The CPU 801 controls image formation so that the trailing edge of the recording material S under image formation does not pass through the transfer roller 15 before the completion of reading the original G. FIG. 6 is a view showing the positional relationship between the recording material S and the original G on the conveyance path at timing t103 in the timing chart of FIG. 5. In the embodiment, as shown in FIG. 6, feeding of the recording material S starts at the same time as the start of reading the original G by the original reading unit 100. However, feeding of the recording material S may start after reading the original G by the original reading unit 100.

As described above, according to the first embodiment, an original reading operation and recording material image forming operation can be parallelly executed with a simple arrangement, thereby increasing the productivity. More specifically, reading of an original, and image formation of read original image data on one surface of a recording material can be parallelly performed with a simple arrangement in which the recording material turnover conveyance path for performing image formation on the two surfaces of a recording material serves as both the recording material conveyance path and the original conveyance path including the original reading unit. Further, the productivity of the image forming apparatus can be increased.

### Second Embodiment

The second embodiment will explain timing control to shorten the conveyance interval between an original and a recording material in order to increase the productivity of an image forming apparatus when the recording material undergoes a double-sided print and one surface of the original is read in the arrangement of the image forming apparatus according to the first embodiment.

[Timing Control in Single-Sided Reading of Original and Double-Sided Print of Recording Material]

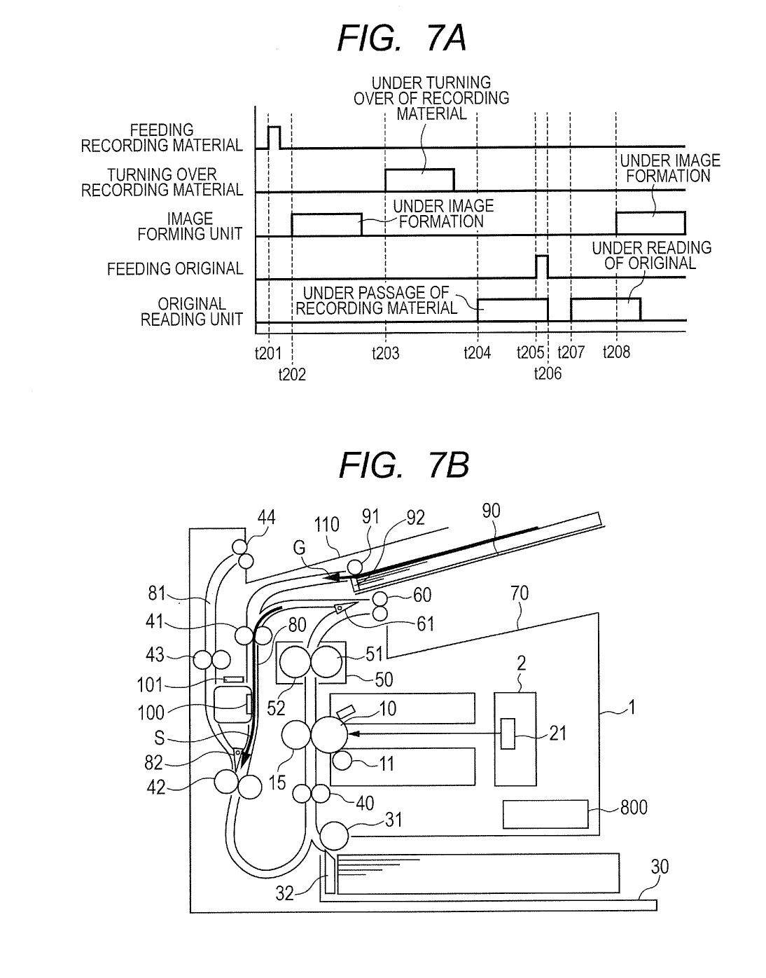

FIG. 7A exemplifies a timing chart when an original is read while a recording material to undergo a double-sided print is being conveyed. In FIG. 7A, the abscissa represents the time, and t201 to t208 are timings in the timing chart. The ordinate represents the states of an original G and recording material S, and the operating state of the apparatus (image forming unit and original reading unit) on the conveyance path. In FIG. 7A, “under turning over of recording material” is a period during which the conveyance path of the recording material S is switched to switch back, to a common conveyance path 80, the recording material S having undergone a single-sided print. “Under passage of recording material” is a period during which the recording material S is passing through an original reading unit 100. The remaining operating states in the timing chart have been described in the first embodiment, and a description thereof will not be repeated. Assume that original image data used in image formation at t202 has been read by the original reading unit 100 before timing t201 and stored in an image memory 804.

At t201, a CPU 801 feeds the recording material S from a first sheet feeding unit 30. At t202 a predetermined time after t201, the CPU 801 performs image formation on the first surface of the recording material S based on the original image data of the original G that is stored in the image memory 804. The recording material S on which the toner image is fixed is conveyed to discharge rollers 60. At t203, if the CPU 801 detects that the trailing edge of the recording material S having undergone image formation on the first surface has passed through a double-sided flapper 61, it stops rotation of the discharge rollers 60 while they clamp the recording material S. When the double-sided flapper 61 switches the conveyance path to switch the conveyance destination of the recording material S to the common conveyance path 80, the CPU 801 reversely rotates the discharge rollers 60 to convey the recording material S to the common conveyance path 80. The switched-back recording material S is conveyed to the original reading unit 100 by conveyance rollers 41. At t204, the conveyance-direction leading edge (to be referred to as a “leading edge” hereinafter) of the recording material S reaches the original reading unit 100. At t206, the conveyance-direction trailing edge (to be referred to as a “trailing edge” hereinafter) of the recording material S passes through the original reading unit 100.

At t205 when the recording material S is passing through the original reading unit 100, the original G is fed from a second sheet feeding unit 90. At t207, the original reading unit 100 starts reading an image on the original G. An output interface circuit 909 of the original reading unit 100 outputs the read image to an ASIC 802, and the ASIC 802 stores it as original image data of the original G in the image memory 804.

In the second embodiment, to increase the productivity of an image forming apparatus 1, it suffices to start feeding of the original G so as to shorten the sheet interval time between t206 when the trailing edge of the recording material S passes through the original reading unit 100 and t207 when the leading edge of the original G reaches the original reading unit 100.

T1 is the timing when the trailing edge of the recording material S passes through the confluence of the original G fed from the second sheet feeding unit 90 and the common conveyance path 80. T2 is the time taken to feed the original G from the second sheet feeding unit 90 and convey it to the confluence of the common conveyance path 80. T3 is the sheet interval time representing the time interval between the trailing edge of the recording material S and the leading edge of the original G in the original reading unit 100. Then, the timing TG to feed the original G from the second sheet feeding unit 90 can be calculated by an equation: TG=T1−T2+T3. FIG. 7B is a view showing the positional relationship between the recording material S and the original G on the conveyance path at timing t205 representing the start of feeding the original G, which is calculated by the equation. When feeding of the original G starts at t205 and the trailing edge of the recording material S passes through the original reading unit 100 at t206, the leading edge of the original G reaches the original reading unit 100 at timing t207 at which the time interval between the recording material S and the original G becomes short.

Note that the timing T1 may use the time taken for the trailing edge of the recording material S to pass through the confluence of the original G fed from the second sheet feeding unit 90 and the common conveyance path 80 after the first sheet feeding unit 30 starts feeding the recording material S. Further, the timing T1 may use the time taken for the trailing edge of the switched-back recording material S to pass through the confluence of the original G and the common conveyance path 80 after the timing when the trailing edge of the recording material S passes through the double-sided flapper 61 to turn over the recording material.

The sheet interval time T3 may be set based on the time necessary to detect the leading and trailing edges of the recording material S and those of the original G by the original reading unit 100 and determine that the recording material S and original G are different originals. The sheet interval time T3 may be a time interval necessary for a sensor (not shown) arranged in the common conveyance path 80 to detect the leading edges of the recording material S and original G. When a dedicated switchback conveyance path (not shown) is formed to discharge the original G, the sheet interval time T3 may be a time necessary to switch the conveyance path of the original G by the switchback flapper 82 and convey the switched-back original G to another conveyance path not to contact the recording material S.

The recording material S conveyed in the common conveyance path 80 passes through conveyance rollers 40, and is conveyed again to the image forming unit. At t208, image formation on the second surface of the recording material S starts. Original image data to form an image on the second surface of the recording material S is image data which has been read by the original reading unit 100 from t207 and stored in the image memory 804.

As described above, according to the second embodiment, an original reading operation and recording material image forming operation can be parallelly executed with a simple arrangement, thereby increasing the productivity. Particularly when an original is read while a recording material is being conveyed in the common conveyance path 80 to perform a double-sided print, feeding of the original starts to shorten the sheet interval time between the recording material and the subsequent original. As a result, conveyance of the recording material and reading of the original can be efficiently performed, and the productivity of the image forming apparatus can be increased.

### Third Embodiment

The third embodiment will explain timing control to shorten the conveyance interval between an original and a recording material in order to increase the productivity of an image forming apparatus when the recording material undergoes a double-sided print and the two surfaces of the original are read in the arrangement of the image forming apparatus according to the first embodiment.

[Timing Control in Double-Sided Reading of Original and Double-Sided Print of Recording Material]

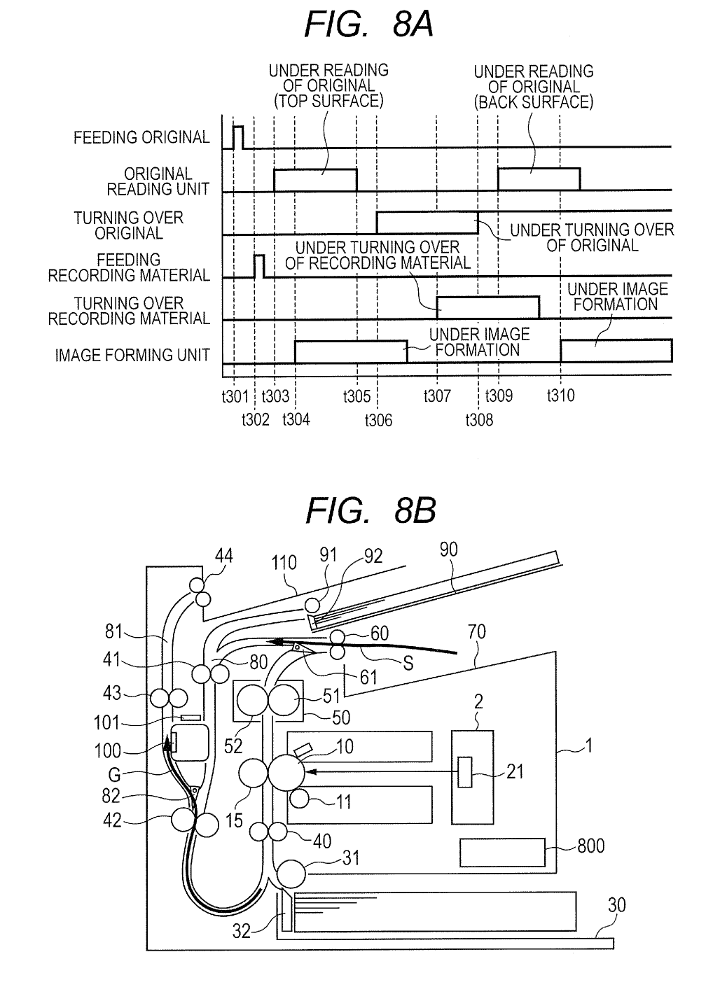

FIG. 8A exemplifies a timing chart when the top surface of an original G is read to print on the first surface of a recording material S, and then the back surface of the original G is read to print on the second surface of the recording material S. In FIG. 8A, the abscissa represents the time, and t301 to t310 are timings in the timing chart. The ordinate represents the states of the original G and recording material S, and the operating state of the apparatus (image forming unit and original reading unit) on the conveyance path. In FIG. 8A, “under turning over of original” is a period during which switching control of the conveyance path is performed to switch back, to an original dedicated conveyance path 81, the original G having undergone reading of the top surface. The remaining operating states in the timing chart have been described in the first and second embodiments, and a description thereof will not be repeated.

At t301, a CPU 801 drives an original pickup roller 91, and conveys the original G stored in a second sheet feeding unit 90 to conveyance rollers 41 by the original pickup roller 91 and a separation member 92. The conveyance rollers 41 convey the original G fed from the second sheet feeding unit 90 to an original reading unit 100. At t303, if the reading sensor of the original reading unit 100 detects the leading edge of the original G, the original reading unit 100 starts reading an image (top surface) on the original G. Upon completion of reading the top surface of the original G by the original reading unit 100 at t305, the original G is conveyed by conveyance rollers 42. At t306 when the trailing edge of the original G passes through a switchback flapper 82, the conveyance of the original G stops, and the original G stops while being clamped by the conveyance rollers 42. Then, the switchback flapper 82 switches the conveyance path to convey the original G from the common conveyance path 80 to the original dedicated conveyance path 81. At t308 when switching to the conveyance path through which the original G is conveyed ends, the conveyance rollers 42 rotate reversely, and the switched-back original G is conveyed to the original reading unit 100 along the original dedicated conveyance path 81.

To increase the productivity of an image forming apparatus 1 in the third embodiment, it suffices to start feeding of the recording material S so as to shorten the interval between the timing when the trailing edge of the switched-back original G completely passes through the common conveyance path 80 and the timing when the leading edge of the recording material S reaches a predetermined point on the common conveyance path 80.

T4 is the timing when the original G is fed from the second sheet feeding unit 90. T5 is the time taken for the trailing edge of the original G, which has been fed from the second sheet feeding unit 90 and switched back to the original dedicated conveyance path 81, to completely pass through a common conveyance path 80. T6 is the time taken for the leading edge of the recording material S fed from a first sheet feeding unit 30 to reach a predetermined point on the common conveyance path 80. Then, the timing TS to feed the recording material S from the first sheet feeding unit 30 can be calculated by an equation: TS=T4+T5−T6.

Note that the time T5 may be the time taken for the trailing edge of the original G switched back by the conveyance rollers 42 to pass through the switchback flapper 82. However, the time T5 needs to be the time taken to convey the recording material S without contacting the trailing edge of the switched-back original G and the switchback flapper 82 whose direction has been switched to convey the original G to the original dedicated conveyance path 81.

Feeding of the recording material S starts at t302 based on the timing calculated by the equation. At t304, image formation on the first surface of the recording material S starts in accordance with the top surface of the original G that has been read by the original reading unit 100 during the interval between t303 and t305. At t307, when the trailing edge of the recording material S having undergone image formation on the first surface passes through a double-sided flapper 61, discharge rollers 60 stop rotation while clamping the recording material S. The double-sided flapper 61 switches the conveyance path to switch the conveyance destination of the recording material S to the common conveyance path 80. Thereafter, the recording material S switched back by reverse rotation of the discharge rollers 60 is conveyed to the common conveyance path 80.

At t308, the original G is switched back through the original dedicated conveyance path 81. At t309, if the reading sensor of the original reading unit 100 detects the leading edge of the original G, the original reading unit 100 starts reading an image (back surface) on the original G. FIG. 8B is a view showing the positional relationship between the recording material S and the original G on the conveyance path at timing t309. When the trailing edge of the switched-back original G passes through the switchback flapper 82, the switchback flapper 82 switches the conveyance path from the original dedicated conveyance path 81 to the common conveyance path 80 to convey the recording material S conveyed in the common conveyance path 80 toward conveyance rollers 40.

The recording material S conveyed to the common conveyance path 80 passes through the original reading unit 100, and is conveyed to the image forming unit via the conveyance rollers 42 and 40. At t310, image formation on the second surface of the recording material S starts in accordance with the back surface of the original G which has been read by the original reading unit 100 from t309.

As described above, according to the third embodiment, an original reading operation and recording material image forming operation can be parallelly executed with a simple arrangement, thereby increasing the productivity. Particularly when a recording material is conveyed to the common conveyance path 80 while an original is being conveyed in the original dedicated conveyance path in order to read the back surface of the original, feeding of the recording material starts to prevent contact between the trailing edge of the original and the leading edge of the subsequent recording material. Thus, reading of the original and conveyance of the recording material can be efficiently performed, and the productivity of the image forming apparatus can be increased.

Although the above embodiments have been described on the premise of the arrangement of an image forming apparatus which forms a monochrome image, the present invention is also applicable to a color image forming apparatus. As the color image forming apparatus, the present invention is applicable to a color image forming apparatus of a type in which photosensitive drums are juxtaposed as image carriers for forming images in yellow, magenta, cyan, and black, and images are transferred from the respective photosensitive drums to a recording material or an intermediate transfer member. Also, the present invention is applicable to a color image forming apparatus of a type in which images of respective colors are sequentially formed on one image carrier (photosensitive drum) to form a color image on an intermediate transfer member and then transfer it to a recording material.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-106109, filed on May 7, 2012, which is hereby incorporated by reference herein in its entirety.

What is claimed is:

1. An image forming apparatus comprising:
a first conveyance path in which a recording material to form an image on the recording material is conveyed;
an image forming unit that forms an image on a recording material conveyed in the first conveyance path;
a second conveyance path in which a conveyance direction of a recording material conveyed in the first conveyance path is switched and conveyed, wherein an image is formed on the recording material by the image forming unit;
a switching unit that, when an original conveyed in the second conveyance path is detected, switches an conveyance path of the original and conveys the original in a third conveyance path;
a reading unit that reads an image of the original conveyed in the second conveyance path and the third conveyance path; and
a control unit that controls a conveyance operation for an original or a recording material to parallelly perform reading of the image of the original by the reading unit and image formation of the read image of the original by the image forming unit.

2. An apparatus according to claim 1, further comprising a first sheet feeding unit that supplies a recording material,
wherein the first sheet feeding unit supplies the recording material to the first conveyance path.

3. An apparatus according to claim 1, further comprising a second sheet feeding unit that supplies the original,
wherein the second sheet feeding unit supplies the original to the second conveyance path.

4. An apparatus according to claim 1, wherein when a trailing edge of the original conveyed in the second conveyance path is detected, the switching unit switches back the original and introduces the original into the third conveyance path.

5. An apparatus according to claim 2, wherein the control unit controls the first sheet feeding unit to prevent a leading edge of the recording material supplied by the first sheet feeding unit from contacting a trailing edge of the original conveyed in the third conveyance path.

6. An apparatus according to claim 3, wherein the control unit controls the second sheet feeding unit to keep a predetermined interval between a leading edge of the original supplied by the second sheet feeding unit and a trailing edge of the recording material conveyed in the second conveyance path.

7. An apparatus according to claim 1, wherein the reading unit includes a sensor that reads the image of the original, and
the sensor faces one of the second conveyance path and the third conveyance path in accordance with an instruction from the control unit.

8. An apparatus according to claim 1, wherein the second conveyance path includes a double-sided conveyance path for forming an image on a second surface of a recording material including a first surface on which an image has been formed.

9. An image forming apparatus comprising:
an image forming unit that forms an image on a recording material;
a conveyance path in which a recording material is conveyed;
a reading unit that reads an original conveyed in the conveyance path; and
a control unit that controls a conveyance operation of a recording material and an original to selectively convey a recording material or an original to the conveyance path.

10. An apparatus according to claim 9, wherein the conveyance path includes a conveyance path for a double-sided print in which a recording material is conveyed in a case where an image on a second surface of a recording material on which an image is formed on a first surface of the recording material.

11. An apparatus according to claim 9, wherein an image is formed on the recording material during an original is conveyed in the conveyance path.

12. An apparatus according to claim 9, wherein the original read by the reading unit is conveyed outward an the image forming apparatus during a recording material is conveyed in the conveyance path.
